(19) United States
(12) Patent Application Publication
(10) Pub. No.: US 2010/0092185 A1
(43) Pub. Date: Apr. 15, 2010

(54) OPTICAL RECEIVER

(75) Inventor: Nobuyuki Nemoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/573,947

(22) Filed: Oct. 6, 2009

(30) Foreign Application Priority Data
Oct. 10, 2008 (JP) 2008-263589

(51) Int. Cl. H04B 10/06; H04B 10/12

(52) U.S. Cl. 398/208; 398/147

(57) ABSTRACT

An optical receiver for receiving a processing modulated optical signal, the optical receiver includes a variable dispersion compensator for receiving the optical signal and for compensating chromatic dispersion of the optical signal in accordance with a predetermined chromatic dispersion value; a demodulator including a delay interferometer for receiving the compensated optical signal and for changing a phase moderation information of the compensated optical signal into an amplitude moderation information, and an optical demodulator for changing the amplitude moderation information of the optical signal into an electrical signal; a data regenerator for extracting a clock from the electric signal and for regenerating data from the electric signal by the use of the clock; and a controller for setting an optical phase to the delay interferometer and for setting the dispersion compensation value to the variable dispersion compensator.

### CROSS-REFERENCE TO RELATED APPLICATION

This application is based upon and claims the benefit of priority of the prior Japanese Patent Application No. 2008-263589, filed on Oct. 10, 2008, the entire contents of which are incorporated herein by reference.

### FIELD

The embodiments discussed herein are related to an optical receiver.

### BACKGROUND

In recent years, with increases in transmission capacity, optical networks allowing DWDM (Dense Wavelength Division Multiplex) transmission are being established. Furthermore, in order to support increases in amount of information to be transmitted, systems at ultra fast rates such as 40 Gb/s are becoming commercially available.

Light modulation methods such as DPSK (Differential Phase Shift Keying) and DQPSK (Differential Quadrature Phase Shift Keying), which are suitable for long distance transmission, tend to be adopted rather than NRZ (Non Return to Zero).

On the other hand, in WDM transmission, the transmission speeds on optical fibers depend on the wavelengths of light. Therefore, as the transmission distance increases, wavelength dispersion occurs in which the pulse waveforms of light become dull. In a WDM system for implementing optical transmission in a large capacity and in a long distance, when wavelength dispersion causes pulse broadening, the reception level is significantly deteriorated, which may have an adverse influence on the system. This may require dispersion compensation that reduces (or cancels) the wavelength dispersion equivalently to zero to inhibit the dispersion occurring on an optical fiber transmission line.

Under dispersion compensation control, the dispersion compensation is performed collectively on a WDM signal on which wavelengths are multiplexed by using a DCF (Dispersion Compensation Fiber). However, because only the dispersion compensation with a DCF is not enough, dispersion compensation for each wavelength is also performed.

In order to perform dispersion compensation for each wavelength, a variable dispersion compensator (VDC) is provided in each of transponders (optical receivers) that perform processing of receiving wavelengths after wavelength division. Furthermore, in order to increase the reliability, the dispersion compensation value (which is a dispersion value with the opposite sign of that of the dispersion value occurring on the optical fiber transmission line) for canceling the wavelength dispersion must be set immediately for the VDC.

Technologies in the past for dispersion compensation may include a proposed technology that calculates the amount of dispersion compensation by using both of the fiber length of a transmission path and a pre-recorded dispersion wavelength dependent characteristic and controls a VDC (e.g. Japanese Laid-open Patent Publication No. 2007-202009 (Paragraphs [0010] to [0012], FIG. 1)). Alternatively, a technology has been proposed which changes the setting of a VDC in the decreasing direction of digital error rate to control for a minimum error rate (e.g. Japanese Patent No. 4011290 (Paragraph [0024], FIG. 1)).

One of optical modulation methods for long distance transmission widely adopted in recent years may be RZ-DQPSK (Return to Zero-Differential Quadrature Phase-Shift Keying: quadrature differential phase modulation method) with high wavelength dispersion tolerance and high PMD (Polarization Mode Dispersion) tolerance.

FIG. 18 is a diagram illustrating the configuration of a transponder. FIG. 18 illustrates the configuration of a transponder that performs processing of receiving RZ-DQPSK modulated signal. A transponder 70 includes a VDC 71, an RZ-DQPSK receiving processing section 72 and a data output section 73.

The VDC 71 receives an optical signal of a single wavelength (or one channel) after the wavelength separation of a transmitted WDM signal and performs dispersion compensation on the optical signal by using a given dispersion compensation value.

The RZ-DQPSK receiving processing section 72 includes delay interferometers 72-1 and 72-2 each of which reproduces the information in phase modulation of an optical signal to the information in intensity modulation and a photodetector 72a that converts an optical signal to an electric signal. The U-DQPSK receiving processing section 72 performs RZ-DQPSK demodulation processing on the optical signal after the dispersion compensation and converts the optical signal to data of the electric signal. The data output section 73 converts receive data into a predetermined format and outputs the result to the next stage.

In the configuration of the transponder 70 in the past as described above, when an optical signal having a significantly large wavelength dispersion beyond the tolerances of the delay interferometers 72-1 and 72-2 is input thereto upon initial start and when the optical phase is far away from the original convergence point, the optical phase setting may be improperly locked.

Once the optical phase setting is improperly locked, it is difficult to adjust it to the original normal optical phase. Even if an optimum dispersion compensation value is set in the VDC 71 after that, it is difficult to demodulate the optical signal main component. This may prevent normal signal communication and may therefore reduce the transmission quality and reliability, which is a problem.

### SUMMARY

According to an aspect of the invention, an optical receiver for receiving a processing modulated optical signal, the optical receiver includes a variable dispersion compensator for receiving the optical signal and for compensating chromatic dispersion of the optical signal in accordance with a predetermined chromatic dispersion value; a demodulator including a delay interferometer for receiving the compensated optical signal and for changing a phase moderation information of the compensated optical signal into an amplitude moderation information, and an optical demodulator for changing the amplitude moderation information of the optical signal into an electrical signal; a data regenerator for extracting a clock from the electric signal and for regenerating data from the electric signal by the use of the clock; and a controller for setting an optical phase to the delay interferometer and for setting the dispersion compensation value to the variable dispersion compensator;

wherein the controller resets the optical phase to the delay interferometer when the controller recognizes that the optical phase has been set in the delay interferometer upon start of the optical receiver but a normal operation of the data regenerator is unperformed within a predetermined period of time, and performs dispersion compensation sequence control that sequentially sets different chromatic dispersion compensation value until an optical phase is set to the delay interferometer and the normal operation by the data regenerator is recognized.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of an optical receiver.

FIG. 2 is a diagram illustrating a configuration of an RZ-DQPSK system.

FIG. 3 is a diagram illustrating a configuration of an RZ-DQPSK system.

FIG. 4 is a QPSK phase diagram.

FIG. 5 is a diagram illustrating an operation by an RZ pulsed intensity-modulator.

FIG. 6 is a diagram illustrating the transmittance of a delay interferometer.

FIG. 7 is a diagram illustrating the transmittance of a delay interferometer.

FIGS. 8A and 8B are diagrams illustrating the directions of the currents flowing through Twin PDs.

FIG. 9 is a diagram illustrating a relationship between the phase difference and the direction of current between the codes.

FIG. 10 is a diagram illustrating how the phase difference between the codes is extracted from the PD current.

FIG. 11 is a diagram illustrating PD differential currents.

FIG. 12 is a diagram illustrating the locking range for optical phase setting and the locking range for clock extraction control.

FIG. 13 is a configuration of an optical receiver.

FIG. 14 is a flowchart illustrating the dispersion compensation sequence control.

FIG. 15 is a flowchart illustrating the dispersion compensation sequence control.

FIG. 16 is a diagram illustrating a dispersion compensation range.

FIG. 17 is a diagram illustrating the locking range for optical phase setting and the locking range for clock extraction control.

FIG. 18 is a diagram illustrating the configuration of a transponder.

### DESCRIPTION OF EMBODIMENTS

An embodiment will be described with reference to drawings below.

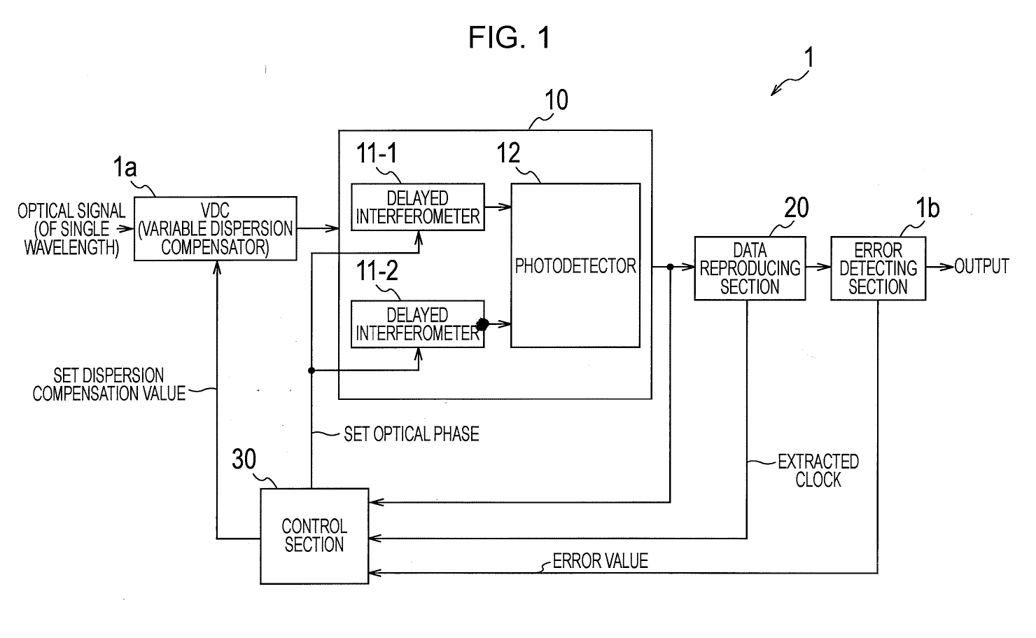

FIG. 1 is a configuration diagram of an optical receiver according to this embodiment. An optical receiver 1 corresponds to a transponder that receives an optical signal on a wavelength-by-wavelength basis. The optical receiver 1 includes a VDC (variable dispersion compensator) 1a, a demodulating section 10, a data reproducing section 20, an error detecting section 1b and a control section 30 and performs processing of receiving a modulated optical signal.

The VDC is receives an optical signal and sets a dispersion compensation value given from the control section 30 to perform dispersion compensation on the optical signal. The demodulating section 10 includes delay interferometers 11-1 and 11-2 and a photodetector 12. The delay interferometers 11-1 and 11-2 convert the information in phase modulation of the optical signal after the dispersion compensation to the information in intensity modulation. The photodetector 12 detects the intensity-modulated optical signal and converts the optical signal to an electric signal.

The data reproducing section 20 extracts a clock from the electric signal and reproduces the data. The error detecting section 1b detects and correct an error in data output from the data reproducing section 20.

The control section 30 is a component block that entirely controls an operation by the optical receiver 1. The control may include, for example, control that sets an optical phase to the delay interferometers 11-1 and 11-2 or control that sets a dispersion compensation value to the VDC 1a.

Here, when, upon start of the apparatus, the control section 30 recognizes that an optical phase has been set to the delay interferometers 11-1 and 11-2 but the data reproducing section 20 does not perform a normal operation within a predetermined period of time, the control section 30 determines that the optical phase has been improperly set. Then, the control section 30 performs dispersion compensation sequence control that sequentially sets different dispersion compensation values until an optical phase is set to the delay interferometers 11-1 and 11-2 and the normal operation by the data reproducing section 20 is recognized.

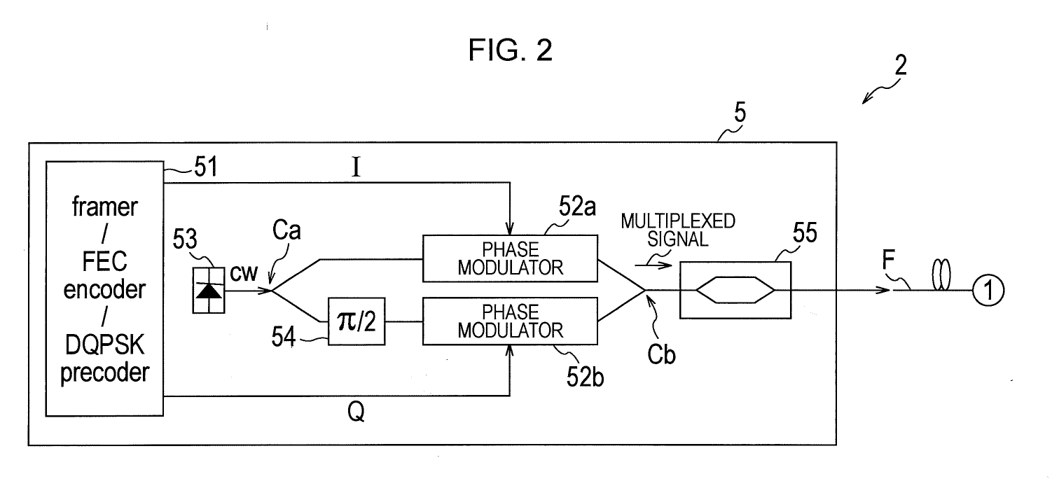

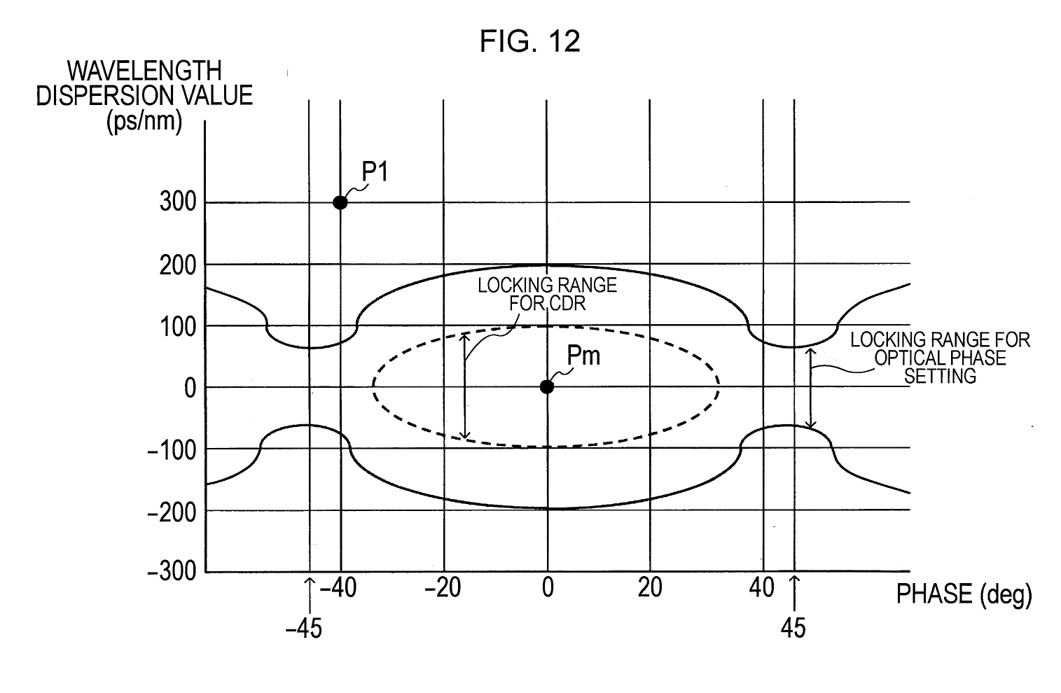

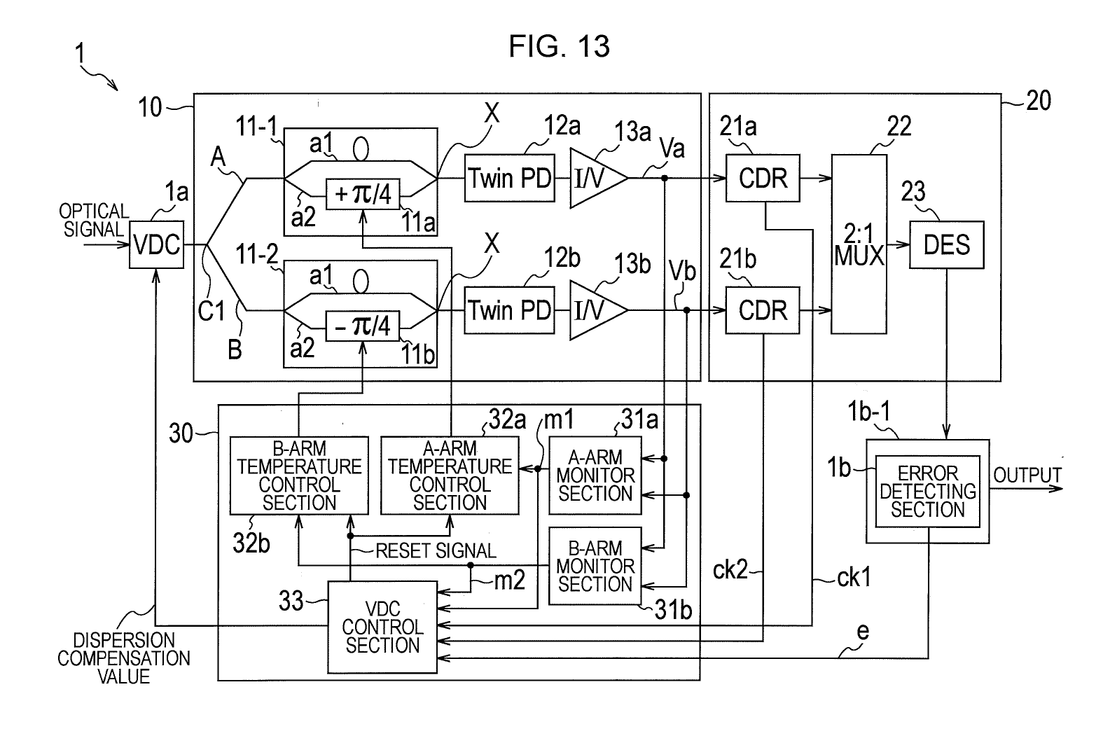

Next, before describing the configuration and operations of the optical receiver 1, the basic concept of and problems to be solved by RZ-DQPSK will be described in detail. The basic concept of RZ-DQPSK will be described with reference to FIG. 2 to FIG. 11, and the problems to be solved will be described with reference to FIG. 12. The details of the optical receiver 1 will be described with reference to FIG. 13 and subsequent drawings.

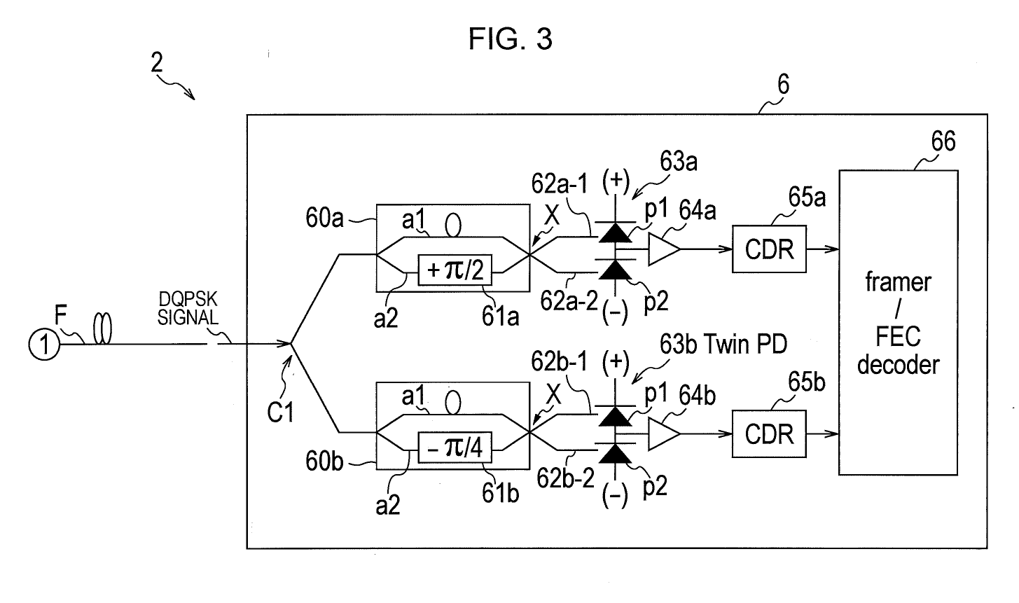

FIG. 2 and FIG. 3 are diagrams illustrating configurations of RZ-DQPSK systems, FIG. 2 illustrates an RZ-DQPSK transmitter 5, and FIG. 3 illustrates an RZ-DQPSK receiver 6. An RZ-DQPSK system 2 includes the RZ-DQPSK transmitter 5 and the RZ-DQPSK receiver 6, which are connected via an optical fiber transmission line F.

The RZ-DQPSK transmitter 5 in FIG. 2 includes a data transmitting section 51, phase modulators 52a and 52b, a light source 53, a branch Ca, a multiplexing section Cb, a π/2 phase shifting section 54 and an RZ pulsed intensity-modulator 55. The RZ-DQPSK transmitter 5 modulates two optical phases at 20 Gbit/sec (which will simply be noted Gbit/sec or G), which are independent from each other, and transmits an optical signal having an amount of information at 40 G to the optical fiber transmission line F.

The data transmitting section 51 outputs two channel signals of an I signal at 20 G and Q signal at 20 G and inputs the I signal to the phase modulator 52a and inputs the Q signal to the phase modulator 52b.

The light source 53 emits continuous light. The branch Ca bifurcates the continuous light, and inputs one branching light beam to the phase modulator 52a and inputs the other light beam to the π/2 phase shifting section 54. The π/2 phase shifting section 54 shifts the phase of the electric field of the light by π/2 and inputs the result to the phase modulator 52b. Here, the π/2 phase shifting section 54 and phase modulator 52b may be arranged in the opposite order, and the amount of shift by the π/2 phase shifting section 54 may be −π/2.

The phase modulator 52a changes the phase of the input light in accordance with the 0 or 1 of the I signal. The phase modulator 52b changes the phase shifted by π/2 of the input light in accordance with 0 or 1 of the Q signal (or if the π/2 phase shifting section 54 and the phase modulator 52b are arranged in the opposite order, changes the phase in accordance with 0 or 1 of the Q signal and then shifts it by π/2). The multiplexing section Cb multiplexes the outputs by the phase modulators 52a and 52b and creates the multiplexed signal.

In this way, phases are modulated separately in accordance with the I signal and Q signal, and the phase-modulated components are multiplexed with a difference of π/2 in phase of the electric field of light therebetween, for performing quadrature phase shift keying (QPSK).

The RZ pulsed intensity-modulator 55 has a clock source, not illustrated, at 20 G in a signal source to be modulated and uses the clock signal at 20 G to repetitively perform intensity modulation on the multiplexed signal the phase of which has been only modulated and shapes the intensity waveform of the multiplexed signal to the waveform of an RZ pulse string. Then, the 40-G optical signal of one wavelength shaped to the RZ pulses is output from the optical fiber transmission line F.

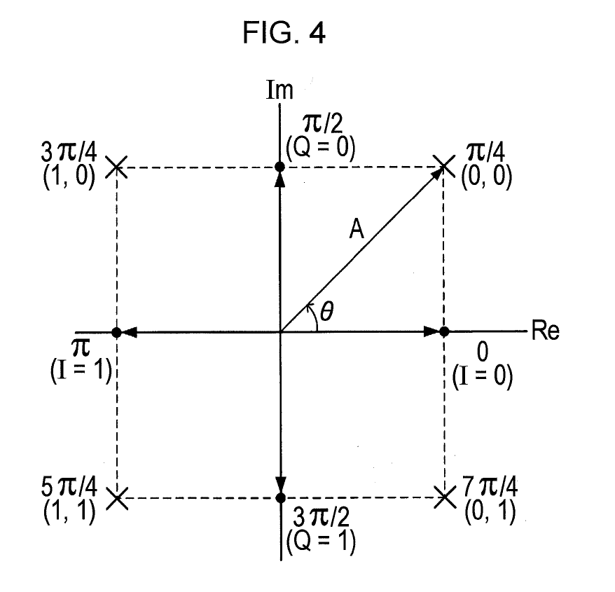

FIG. 4 is a QPSK phase diagram. The horizontal axis indicates a real part Re, and the vertical axis indicates imaginary part Im. Here, the function E(t) in time of the electric field of light may be expressed by:

$$\begin{matrix}E ( t ) = A ( t ) * exp ( j ( ω t - θ ( t ) ) ) & ( 1 a ) \\ = A ( t ) * exp ( - j θ ( t ) ) * exp ( j ω t ) & ( 1 b )\end{matrix}$$

where the amplitude is A(t), the function representing the vibration of the electric field is exp(j(ω)t−θ(t))), and Expression is developed to Expression 1b. The phase diagram illustrates the part A(t)exp(−jθ(t)) in Expression 1b in a complex plane.

The modulation by the phase modulator 52a with the I signal determines either 0 (I=0) or π (I=1) in the real axis upper direction in the phase diagram illustrated FIG. 4. The modulation by the phase modulator 52b with the Q signal, which means a rotation by π/2 from the I signal, determines either π/2 (Q=0) or π/2 (Q=1) in the imaginary axis direction.

Then, multiplexing the modulated signals by the multiplexing section Cb corresponds to the orthogonal addition on the real axis and the imaginary axis in the phase diagram. Therefore, the optical signal (or multiplexed signal) has phase states of π/4 (0,0), π/4 (1,0), πt/4 (1,1) and π/4 (0,1) (adjacent phases are all orthogonal).

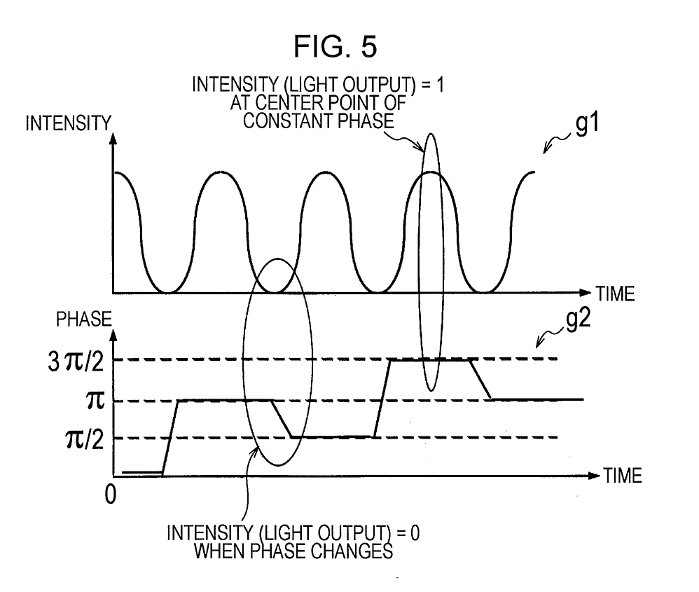

FIG. 5 is a diagram illustrating an operation by the RZ pulsed intensity-modulator 55. The graph g1 has a horizontal axis indicating time and a vertical axis indicating intensity and illustrates intensity pulses of light from the RZ pulsed intensity-modulator 55. The graph g2 has a horizontal axis indicating time and a vertical axis indicating phase and illustrates phase states of the multiplexed signal that varies in time.

When the phase of the multiplexed signal changes, the RZ pulsed intensity-modulator 55 extinguishes the output (which means light output=0) such that the instance when the phase changes and the bottom of the intensity pulses can agree. When the phases of the multiplexed signal are constant, the RZ pulsed intensity-modulator 55 increases the intensity of the output (to light output=1) and shapes RZ pulses such that the center of the code of the multiplexed signal can agree with the peak of the intensity pulses.

Notably, even when the RZ pulsed intensity-modulator 55 does not exist as a component of the transmitter, the phase-modulated data can be transmitted. However, shaping the phase-modulated signal to an RZ pattern and outputting it to the optical fiber transmission line F can reduce the distortion caused by a non-linear effect of an optical signal on the optical fiber transmission line F.

Next, referring back to FIG. 3, the RZ-DQPSK receiver 6 will be described. The RZ-DQPSK receiver 6 includes a branch C1, delay interferometers 60a and 60b, Twin PDs (Photodiodes) 63a and 63b, which are dual pin photodiodes that perform differential photoelectric conversion detection (or balanced detection), preamplifier sections 64a and 64b, CDRs (Clock Data Recoveries) 65a and 65b, and a data receiving section 66. The RZ-DQPSK receiver 6 performs processing of demodulating and receiving the 40-G optical modulated signal.

The branch C1 bifurcates the received optical signal of one wavelength and outputs the bifurcated optical signals to the delay interferometers 60a and 60b. The delay interferometers 60a and 60b are provided for the bifurcated two channels. The delay interferometers 60a and 60b function as a Mach-Zehnder interferometer and independently reproduce the information in phase modulation of optical signals to the information in intensity modulation.

The delay interferometer 60a has two waveguides (which will be called arms) a1 and a2, and one arm a2 of them has a π/4 phase shifter 61a. A control section, not illustrated, adjusts the index of refraction of the arm, which corresponds to the n/4 phase shifter 61a, whereby the optical phase difference between the arms at an interference point X can be equal to it/4. The arm on the arm a1 side without the phase shifter 61a has a longer optical path length, which can give a delay equal to approximately one encoding period.

This causes the one previous code having passed the optical path of the arm a1 and the code resulting from the shift by the phase difference π/4 of the currently received code having passed the optical path of the arm a2 to interfere at the interference point X. Notably, the delay interferometer 60b is different from the delay interferometer 60a having the −π/4 phase shifter 61b in one arm a2, but other basic operations are the same as those of the delay interferometer 60a.

The delay interferometers 60a and 60b have upper output arms 62a-1 and 62b-1 and lower output arms 62a-2 and 62b-2, respectively, as two output arms that output the light interfered at the interference point X. The output values by the upper output arms 62a-1 and 62b-1 and the output values by the lower output arms 62a-2 and 62b-2 have a complementary relationship. For example, if the output value by the upper output arm 62a-1 is “+a”, the output value by the lower output arm 62a-2 is “−a”.

The Twin PDs (differential optical receivers) 63a and 63b are O/E converting sections and are direct photodetectors that directly detect the intensity-modulated optical signals and directly replace the light intensity by a current signal. Each of the Twin PDs 63a and 63b has a configuration that two PD p1 and PD p2 are connected and outputs from the connection point.

The cathode of the upper PD p1 is applied plus bias voltage, and the anode of the upper PD p1 connects to the cathode of the lower PD p2. The anode of the lower PD p2 is applied minus bias voltage. The upper output arms 62a-1 and 62b-1 in the delay interferometers 60a and 60b connect to the upper PDs p1 of the Twin PDs 63a and 63b, respectively. The Twin PDs 63a and 63b of the lower output arms 62a-2 and 62b-2 connect to the lower PDs p2, respectively.

The CDRs 65a and 65b have clock extraction and binary threshold value determination functions. The CDRs 65a and 65b perform clock recovery and binary value determination on the signals I/V (current/voltage)-converted by the preamplifier sections 64a and 64b and create and output digital signals. Notably, the CDRs 65a and 65b internally have PLLs (Phase-locked loops), and the PLLs are locked (or synchronized) to perform clock extraction.

The data receiving section 66 performs a predetermined data receiving processing routine by receiving a 20-Gbps digital signal output from the CDR 65a and a 20 Gbps-digital signal output from the CDR 65b. At that time, the 20-G digital signals from the two channels may be serially multiplexed to be output as a 40-G digital signal.

The data receiving section 66 may further function as a framer that performs frame processing for an OTN (Optical Transport Network) or an SDH/SONET (Synchronous Digital Hierarchy/Synchronous Optical Network), an FEC (Forward Error Correction) decoder and so on.

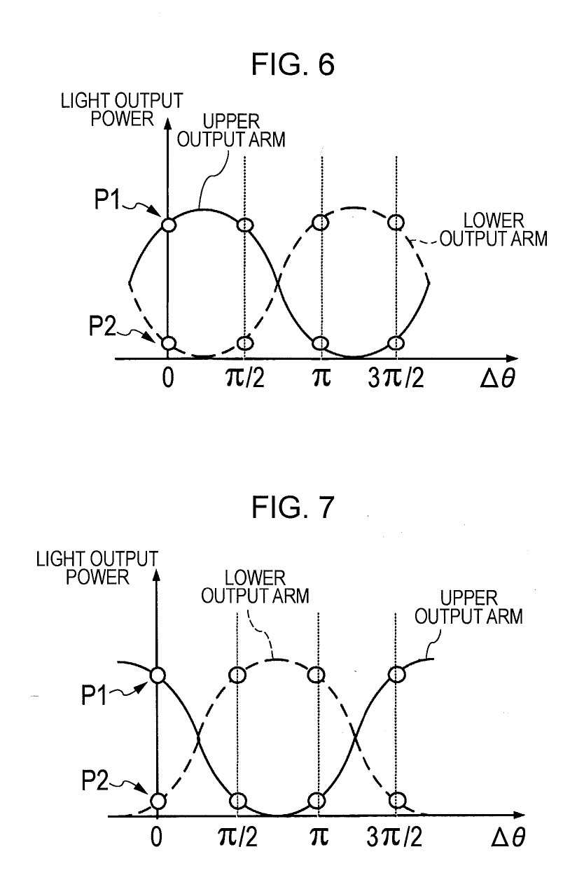

Here, the QPSK demodulation operation will be described in detail with reference to FIG. 6 to FIG. 9. FIG. 6 and FIG. 7 are diagrams illustrating the transmittances of the delay interferometers 60a and 60b. The horizontal axis indicates phase difference Δθ between two codes, which are relatively delayed, arriving at the interference point X, that is, the ith code and the (i−1)th code, and the vertical axis indicates light output power by the delay interferometers 60a and 60b. In the figures, the solid lines indicate the light output powers by the upper output arms 62a-1 and 62b-1, and the dashed lines indicate the light output powers by the lower output arms 62a-2 and 62b-2.

The delay interferometers 60a and 60b cause one previously arriving code and the code resulting from the addition of a 44 phase difference to the currently arriving code. Therefore, Δθ for a maximum or minimum interference at the interference point X is −π/4.

Against the transmittance of the delay interferometer 60a in FIG. 6, if the phase difference Δθ=0 between the codes, the light output by the upper output arm 62a-1 is the light output P1. If Δθ=t/2, the light output by the upper output arm 62a-1 is also the light output P1. If Δθ=0, π/2, the light outputs relatively strength each other (where the interferometers are configured to have a difference of 0 to π/4 if Δθ=0, π/2 such that equal light output values can be acquired). If Δθ=π, 3π/2, the outputs by the upper output arm 62a-1 are the light outputs P2, which are outputs relatively weakening each other (also where because a difference of 0 to 44 is given, equal light output values are acquired if Δθ=π, 3π/2).

On the other hand, the light output by the lower output arm 62a-2 has a complementary relationship with the light output by the upper output arm 62a-1 (which means that the value resulting from the addition of the light output by the upper output arm 62a-1 and the light output by the lower output arm 62a-2 with an equal phase difference Δθ is therefore typically constant). In other words, if Δθ=0, π/2, the light outputs by the lower output arm 62a-2 are the light outputs P2, which relatively weakening each other. If Δθ=π, 3π/2, the light outputs by the lower output arm 62a-2 are the light outputs P1, which relatively strengthen each other.

The upper output arm 62a-1 connects to the upper PD p1 of the Twin PD 63a, the lower output arm 62a-2 connects to the lower PD p2 of the Twin PD 63a. Therefore, if Δθ=0, π/2, a larger amount of current is fed to the upper PD p1 while if Δθ=π, 3π/2, a larger amount of current is fed to the lower PD p2.

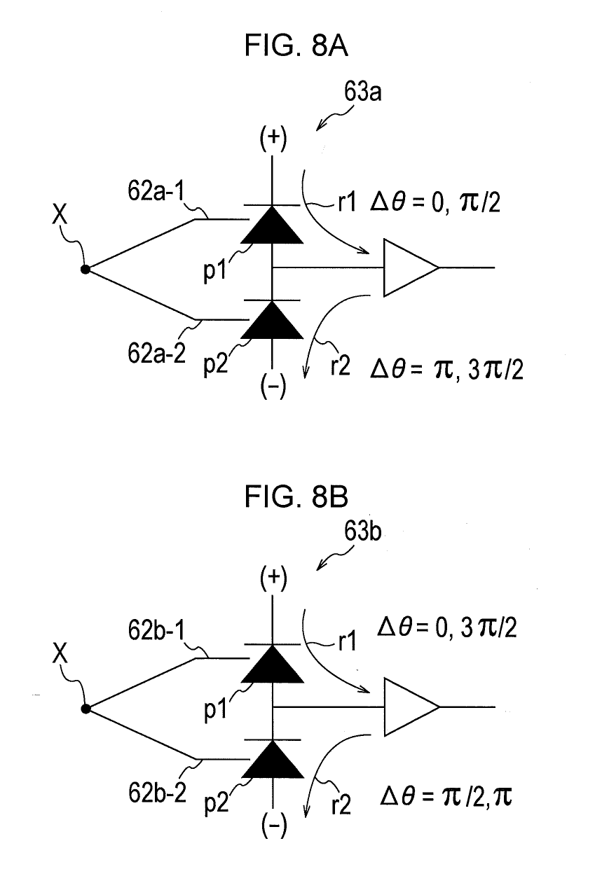

FIGS. 8A and 8B are diagrams illustrating the directions of the currents flowing through the Twin PDs 63a and 63b. FIG. 8A illustrates the direction of the current flowing through the Twin PD 63a, and FIG. 8B illustrates the direction of the current flowing through the Twin PD 63b.

Referring to FIG. 8A, when a larger amount of current is fed to the upper PD p1, the direction of the output current from the Twin PD 63a is the arrow r1 (plus output current), and when a larger amount of current is fed to the lower PD p2, the direction of the output current from the Twin PD 63a is the arrow r2 (minus output current), as illustrated.

Focusing on the transmittance of the delay interferometer 60b in the same manner, if the phase difference Δθ=0 and Δθ=0, 3π/2 between the codes, the light outputs by the upper output arm 62b-1 are the light outputs P1, which are light outputs relatively strengthening each other, and if Δθ=π/2, π, the light outputs by the upper output arm 62b-1 are the light outputs P2, which are light outputs relatively weakening each other.

If Δθ=0, 3π/2, the light outputs by the lower output arm 62b-2 are the light outputs P2, which relatively weaken each other. If Δθ=π/2, π, the light outputs by the lower output arm 62b-2 are light outputs P1, which strengthen each other.

Therefore, if Δθ=0, 3π/2, a larger amount of current is fed to the upper PD p1. If Δθ=π/2, π, a larger amount of current is fed to the lower PD p2. As illustrated in FIG. 8B, when a larger amount of current is fed to the upper PD p1, the direction of the output current from the Twin PD 63b is the arrow r1 (plus output current). When a larger amount of current is fed to the lower PD p2, the direction of the output current from the Twin PD 63b is the arrow r2 (minus output current).

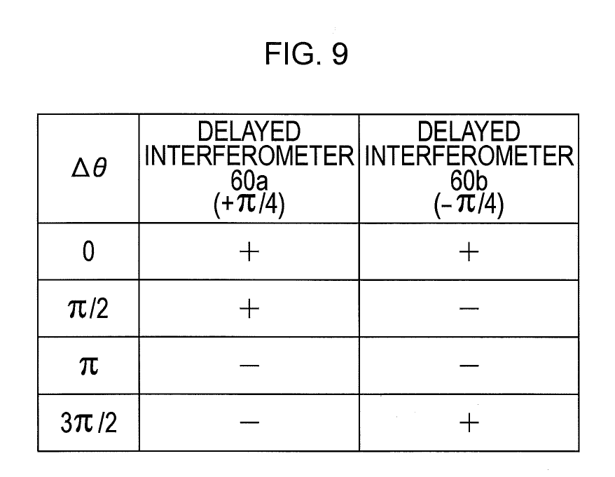

FIG. 9 is a diagram illustrating the relationships between the phase differences Δθ between the codes and the directions of current. In the delay interferometer 60a, because the output currents by the Twin PD 63a are plus currents if Δθ=0, π/2, they are indicated by “+”. Because the output currents by the Twin PD 63a are minus currents if Δθ=π, 3π/2, they are indicated by “−”.

In the same manner, in the delay interferometer 60b, if Δθ=0, 3π/2, the output currents by the Twin PD 63b are plus currents. Therefore, they are indicated by the “+” in the figure. If Δθ=π/2, π, the output currents by the Twin PD 63b are minus currents. Therefore, they are indicated by “=”.

Here, in the transmitter side, the phase difference takes a quadrature value for each π/2, which means that four phase differences exist between the one previously arriving code and the currently arriving code also in the receiver side. If the phase does not rotate, Δθ=0. If the phase moves by one in counterclockwise direction, Δθ=π/2. If by two, Δθ=π. If by three, Δθ=3π/2. In addition, in accordance with the number of rotations of the phase between the one previously arriving code and the currently arriving code, the output current by the Twin PD is either one of the two + and −.

Therefore, in one delay interferometer 60a and Twin PD 63a, two states are extracted from the quadrature phase modulations (which means that the half 20-G information is extracted from the transmitted 40-G information). Also in the other delay interferometer 60b and Twin PD 63b, the other two states are extracted from the quadrature phase modulations.

Therefore, from the two pairs of the delay interferometer 60a and Twin PD 63a and the delay interferometer 60b and Twin PD 63b, four combinations of + and − of (+, +), (+, −), (−, −) and (−, +) are reproduced. In the subsequent processing, the subsequent CDRs 65a and 65b convert the plus/minus current signal to a voltage signal, performs 0/1 bit determination on the voltage signal on the basis of a threshold value, and thus creates a digital signal.

In this way, the RZ-DQPSK receiver 6 has two channels having substantially similar circuit configurations to perform the demodulation processing and thus performs the RZ-DQPSK receiving processing. Therefore, the circuit configurations can be simplified.

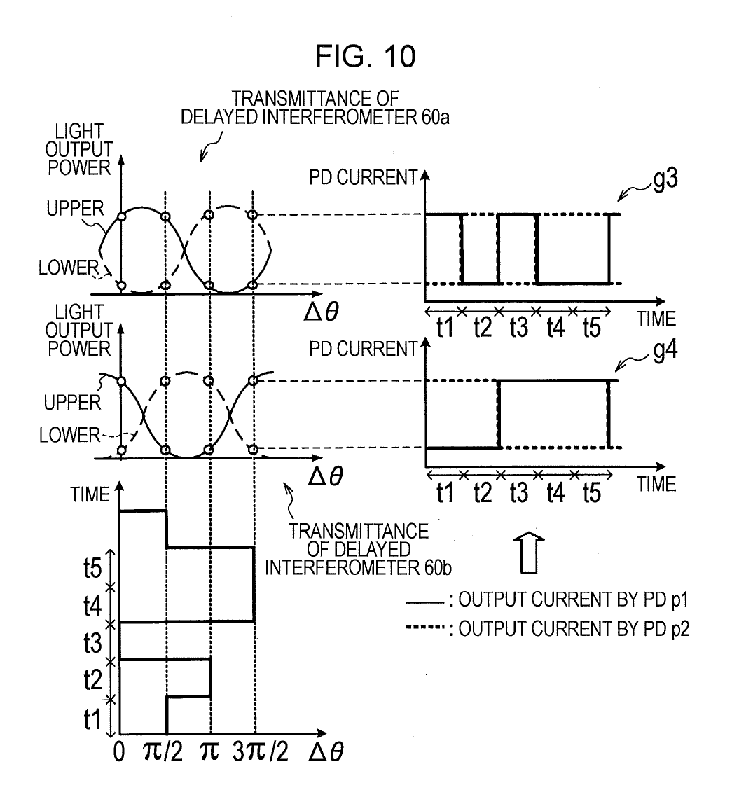

FIG. 10 is a diagram illustrating how the phase differenceΔθ between the codes is extracted from the PD current. FIG. 10 illustrates an example in which an RZ-DQPSK receive signal is modulated in the order of π/2→π→0→3π/2→3π/2→π/2→0, and the delay interferometers 60a and 60b output the corresponding PD currents (which are output currents from the Twin PDs 63a and 63b) in the order of the phase differences.

In the delay interferometer 60a, if Δθ=π/2, the power by the upper output arm 62a-1 is high while the power by the lower output arm 62a-2 is low because of the transmittance of the delay interferometer 60a. Therefore, at the time t1 on the graph g3, PD p1 has a plus output current, and PD p2 has a minus output current.

If Δθ=π, the power by the upper output arm 62a-1 is low while the power by the lower output arm 62a-2 is high because of the transmittance of the delay interferometer 60a. Therefore, at the time t2 on the graph g3, the PD p1 has a minus output current, and the PD p2 ahs a plus output current.

If Δθ=0, the power by the upper output arm 62a-1 is high while the power by the lower output arm 62a-2 is low because of the transmittance of the delay interferometer 60a. Therefore, at the time t3 on the graph g3, the PD p1 has a plus output current, and the PD p2 has a minus output current.

If Δθ=3π/2, the power by the upper output arm 62a-1 is low while the power by lower output arm 62a-2 is high because of the transmittance of the delay interferometer 60a. Therefore, at the time t4 on the graph g3, the PD p1 has a minus output current, and the PD p2 has a plus output current.

If Δθ=3π/2, the power by the upper output arm 62a-1 is low while the power by the lower output arm 62a-2 is high because of the transmittance of the delay interferometer 60a. Therefore, at the time t5 on the graph g3, the PD p1 has a minus output current, and the PD p2 has a plus output current.

On the other hand, in the delay interferometer 60b, if Δθ=π/2, the power by the upper output arm 62b-1 is low while the power by the lower output arm 62b-2 is high because of the transmittance of the delay interferometer 60b. Therefore, at the time t1 on the graph g4, PD p1 has a minus output current while PD p2 has a plus output current.

If Δθ=π, the power by the upper output arm 62b-1 is low while the power by the lower output arm 62b-2 is high because of the transmittance of the delay interferometer 60b. Therefore, at the time t2 on the graph g4, the PD p1 has a minus output current while the PD p2 has a plus output current.

If Δθ=0, the power of the upper output arm 62b-1 is high while the power of the lower output arm 62b-2 is low because of the transmittance of the delay interferometer 60b. Therefore, at the time t3 on the graph g4, the PD p1 has a plus output current while the PD p2 has a minus output current.

If Δθ=3π/2, the power of the upper output arm 62b-1 is high while the power of lower output arm 62b-2 is low because of the transmittance of the delay interferometer 60b. Therefore, at the time t4 on the graph g4, the PD p1 has a plus output current while the PD p2 has a low output current.

If Δθ=3π/2, the power of the upper output arm 62b-1 is high while the power of the lower output arm 62b-2 is low because of the transmittance of the delay interferometer 60b. Therefore, at the time t5 on the graph g4, the PD p1 has a plus output current while the PD p2 has a minus output current.

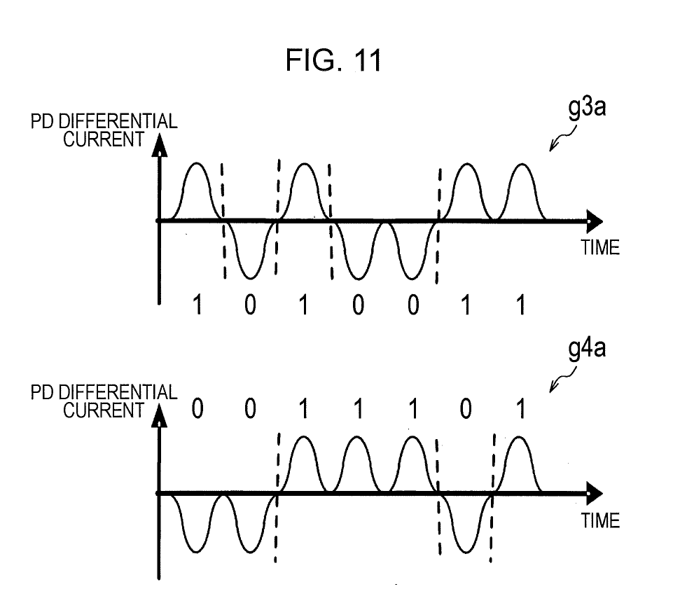

FIG. 11 is a diagram illustrating PD differential currents. The horizontal axis indicates time, and the vertical axis indicates PD differential current. The PD differential current is a current value resulting from the subtraction of the output current by the PD p2 from the output current by the PD p1. The PD differential current as illustrated on the graph g3a can be acquired from the waveform on the graph g3, and the PD differential current as illustrated on the graph g4a can be acquired from the waveform on the graph g4. Therefore, the receive signals are demodulated to (1, 0), (0, 0), (1, 1), (0, 1), (0, 1), (1, 0), (1, 1) . . . .

Problems to be solved will be described next. As described above, the arm a2 of the delay interferometer 60a has the π/4 phase shifter 61a, and the light beams passed through two waveguides are caused to interfere with an optical phase difference of π/4 between the arms at the interference point X. The arm a2 of the delay interferometer 60b has the −π/4 phase shifter 61a, and the light beams passed through two waveguides are caused to interfere with an optical phase difference of −π/4 between the arms at the interference point X.

If an optical phase of π/4 is correctly set in the delay interferometer 60a and an optical phase of −π/4 is correctly set in the delay interferometer 60b, the level resulting from the differential photoelectric conversion and detection on an light output by the delay interferometer 60a and averaging the signals output from the subsequent preamplifier section 64a agrees with the level resulting from the differential photoelectric conversion and detection on an light output by the delay interferometer 60b and averaging the signals output from the subsequent preamplifier section 64b.

Notably, if the optical phase in one or both of the delay interferometers 60a and 60b are not correctly adjusted to π/4 and/or −π/4, two signal levels differ.

Therefore, it is important to handle the value resulting from the subtraction of the output level by the preamplifier section 64a from the output level by the preamplifier section 64b as a monitor value on the delay interferometer 60a side and the value resulting from the subtraction of the output level by the preamplifier section 64b from the output level by the preamplifier section 64a as a monitor value on the delay interferometer 60b side and control such that the two monitor values can be equal to 0 which means that proper demodulation can be performed thereon. Notably, the state, that an optical phase has been completely set in a delay interferometer, that is, the state that the monitor values are equal to 0 is called the state that “the optical phase setting is locked”.

Here, if, upon initial start of the apparatus, the residual dispersion value of an optical signal input to the delay interferometers 60a and 60b is out of the operation range of the delay interferometers 60a and 60b and the optical phase is far away from the convergence point, the optical waveform does not keep the original form, which destabilizes the output signals from the Twin PDs 63a and 63b. Therefore, it is difficult to extract the main signal component from the received optical signals.

Under this condition, the state may occur that the monitor value on the delay interferometer 60a side and the monitor value on the delay interferometer 60b side can both be equal to 0. The state that the monitor values are equal to 0 even though the optical phases are not normally set is called “optical phase setting improper locking state”.

Because the optical phases are not actually adjusted to an optimum point, the next CDRs 65a and 65b may not extract clocks therefrom, and the main signals are not demodulated, which causes a state with continuous occurrence of errors. As a result, the control may terminate. The state that the clock extraction control is performed normally in a CDR may be described as “the clock extraction control is locked” or “CDR lock” in the following description.

FIG. 12 is a diagram illustrating the locking range for the optical phase setting and the locking range for the clock extraction control. The vertical axis indicates wavelength dispersion value (ps/nm), and the horizontal axis indicates phase (deg). FIG. 12 illustrates a relationship between a residual dispersion value input to the delay interferometers 60a and 60b and the corresponding optical phase. In order to normally operate the optical receiver, it is important that the optical phase setting is positioned in the inner locking range indicated by the solid line and the clock extraction control is positioned in the inner locking range indicated by the dashed line.

When the residual dispersion value of light input to the delay interferometers 60a and 60b and the optical phase upon start of the receiver cross at the point P1 indicated by the illustrated black dot (where the residual dispersion value=300 ps/nm and the optical phase=−40°), they are out of the locking range of the delay interferometers 60a and 60b and are out of the CDR locking range (where the point Pm is the optimum point with a highest transmission characteristic).

This may cause the case where the monitor value on the delay interferometer 60a side and the monitor value on the delay interferometer 60b side are equal to 0.

Then, the optical phase setting control terminates on the basis of the determination that the optical phase settings in the delay interferometers 60a and 60b are locked. However, because the point P1 is out of the CDR locking range, it is difficult to extract the clock, which prevents the reproduction of the main signal.

As described above, if the residual dispersion value of the optical signal input to the delay interferometers is significantly higher than the dispersion value tolerable by the delay interferometers and the optical phase is far away from the convergence point, there may be a possibility of occurrence of the improper lock of the optical phase setting in the delay interferometers.

In an RZ-DQPSK receiver in the past, because the lock of the optical phase setting is not identified as either normal lock or improper lock, it is determined that the optical phase setting has completed normally and the receiving processing is attempted to continue, even though it is the improper lock. As a result, the main signal may not be demodulated, and the error state of the receiver may continue.

Next, the configuration and operations of the optical receiver 1 that solves the problems will be described with reference to a case where RZ-DQPSK receiving processing is performed.

FIG. 13 is a configuration of the optical receiver 1. The optical receiver 1 includes a VDC 1a, a demodulating section 10, a data reproducing section 20, an OTN section 1b-1 and a control section 30.

The demodulating section 10 has a branch C1, delay interferometers 11-1 and 11-2, Twin PDs 12a and 12b, and preamplifiers 13a and 13b. The data reproducing section 20 includes CDR sections 21a and 21b, a multiplexing section 22 and a DES (DE-Serializer) 23. The OTN section 1b-1 has an error detecting section 1b.

The control section 30 has an A arm monitor section 31a, a B arm monitor section 31b, an A arm temperature control section 32a, a B arm temperature control section 32b and a VDC control section 33.

The branch C1 bifurcates an optical signal of a single wavelength output from the VDC is into two channels and outputs the bifurcated optical signals to the delay interferometers 11-1 and 11-2. Notably, the delay interferometer 11-1 side may also be referred as A arm, and the delay interferometer 11-2 side may also be referred as B arm.

The delay interferometers 11-1 and 11-2 are provided for the bifurcated two channels. The delay interferometers 11-1 and 11-2 function as a Mach-Zehnder interferometer and independently reproduce the information in phase modulation of optical signals to the information in intensity modulation.

The delay interferometer 11-1 has two arms a1 and a2 and a π/4 phase shifter 11a near one arm a2 of the two arms and adjusts such that the optical phase difference between the arms at an interference point X can be equal to π/4 under the control over the optical phase setting from the control section 30.

The delay interferometer 11-2 has two arms a1 and a2 and a −π/4 phase shifter 11b near one arm a2 of the two arms and adjusts such that the optical phase difference between the arms at an interference point X can be equal to −π/4 under the control over the optical phase setting from the control section 30.

The π/4 phase shifter 11a and −π/4 phase shifter 11b include a heater that locally varies the temperature of waveguides to vary the optical phase, a temperature sensor and a Peltier device that adjusts the increase/decrease in heating value in accordance with the applied voltage, not illustrated, which are controlled on the basis of an optical phase setting signal from the control section 30.

The Twin PDs 12a and 12b perform direct detection on an intensity-modulated optical signal and replace a light intensity by a current signal. The preamplifier 13a converts an optical current output from the Twin PD 12a to a voltage signal Va (I/V conversion), and the preamplifier 13b converts an optical current output from the Twin PD 12b to a voltage signal Vb.

The CDR sections 21a and 21b have a PLL-based clock extraction function and a binary threshold value determining function. The CDR section 21a extracts a clock ck1 from the voltage signal Va output from the preamplifier 13a, performs binary identification and determination thereon and notifies the result to the VDC control section 33 included in the control section 30. The CDR section 21a creates digital data therefrom and outputs the digital data to the multiplexing section 22 included in the data reproducing section 20.

In the same manner, the CDR section 21b extracts a clock ck2 from the voltage signal Vb output from the preamplifier 13b, performs binary identification and determination thereon and notifies the result to the VDC control section 33 included in the control section 30. The CDR section 21b creates digital data therefrom and outputs the digital data to the multiplexing section 22 included in the data reproducing section 20.

The multiplexing section 22 multiplexes the digital data output from the CDR section 21a and the digital data output from the CDR section 21b and outputs a serial signal. The DES 23 performs serial/parallel conversion thereon and converts the serial signal output from the multiplexing section 22 to a parallel signal.

The OTN section 1b-1 has an error detecting section 1b having an FEC function and performs error detection and correction on the signal output from the DES 23, transmits the error value e to the VDC control section 33 and corrects the error. Notably, the OTN section 1b-1 further has a framer function, in addition to the FEC error detection, and configures and outputs the digital signal after the error correction to a frame in a format based on the optical network standard called OTN.

As the demodulated signal on the A arm side, the A arm monitor section 31a receives the voltage signal Va output from the preamplifier 13b, performs filtering and smoothing thereon and creates average signal (which will be called SVa). As the demodulated signal on the B arm side, the A arm monitor section 31a receives the voltage signal Vb output from the preamplifier 13a, performs filtering and smoothing thereon and creates the average signal (which will be called SVb). Then, the A arm monitor section 31a subtracts the average signal SVa from the average signal SVb and outputs the subtracted level value as a monitor value m1.

The A arm temperature control section 32a receives the monitor value m1 and determines the level of the monitor value m1. If the level of the monitor value m1 is higher than 0, the A arm temperature control section 32a performs optical phase control on the A arm side (or control for adjusting and setting +π/4) including temperature control by applying a signal that lowers the temperature to the π/4 phase shifter 11a to reduce the delay (which means reducing the optical path length of the arm a2 in the delay interferometer 11-1).

If the level of the monitor value m1 is lower than 0, the temperature control section 32a performs temperature control by applying a signal that raises the temperature to the π/4 phase shifter 11a to increase the delay (which means increasing the optical path length of the arm a2 in the delay interferometer 11-1).

On the other hand, as the demodulated signal on the B arm side, the B arm monitor section 31b receives the voltage signal Vb output from the preamplifier 13b, performs filtering and smoothing thereon and creates the average signal SVb. As the demodulated signal on the A arm side, the B arm monitor section 31b receives the voltage signal Va output from the preamplifier 13a, performs filtering and smoothing thereon and creates the average signal SVa. Then, the B arm monitor section 31b subtracts the average signal SVb from the average signal SVa and outputs the subtracted level value as a monitor value m2.

The B arm temperature control section 32b receives the monitor value m2 and determines the level of the monitor value m2. If the level of the monitor value m2 is higher than 0, the A arm temperature control section 32a performs optical phase control on the B arm side (or control for adjusting and setting −π/4) including temperature control by applying a signal that lowers the temperature to the −π/4 phase shifter 11b to reduce the delay (which means reducing the optical path length of the arm a2 in the delay interferometer 11-2).

If the level of the monitor value m2 is lower than 0, the temperature control section 32b performs temperature control by applying a signal that raises the temperature to the −π/4 phase shifter 11b to increase the delay (which means increasing the optical path length of the arm a2 in the delay interferometer 11-2).

The VDC control section 33 receives the monitor value m1, monitor value m2, clock ck1, clock ck2, and error value e. Regarding the monitor values m1 and m2, if the monitor value m1 is equal to 0, it is determined that the delay interferometer 11-1 has undergone the optical phase setting (with a shift of +π/4 phase). If the monitor value m2 is equal to 0, it is determined that the delay interferometer 11-2 has undergone the optical phase setting (with a shift of −π/4 phase). However, as described above, it does not typically means that the optical phase has been normally set, but the value or values might be equal to 0 by incorrect setting. Therefore, the recognition of the optical phase setting only determines whether the monitor values m1 and m2 are equal to 0 or not.

On the other hand, regarding the clocks ck1 and ck2, if both of the clocks ck1 and ck2 are normally received, it is determined that the CDRs 21a and 21b are normal operating, that is, the data reproducing section 20 is normally operating (or the clock extraction control is locked or the CDR is locked). Notably, the error value e is used for finely adjusting the dispersion compensation value. In order to minimize the error value e, the dispersion compensation value to be set to the VDC is finely adjusted. The VDC control section 33 transmits a reset signal to the A arm temperature control section 32a and B arm temperature control section 32b to reset the optical phase setting control.

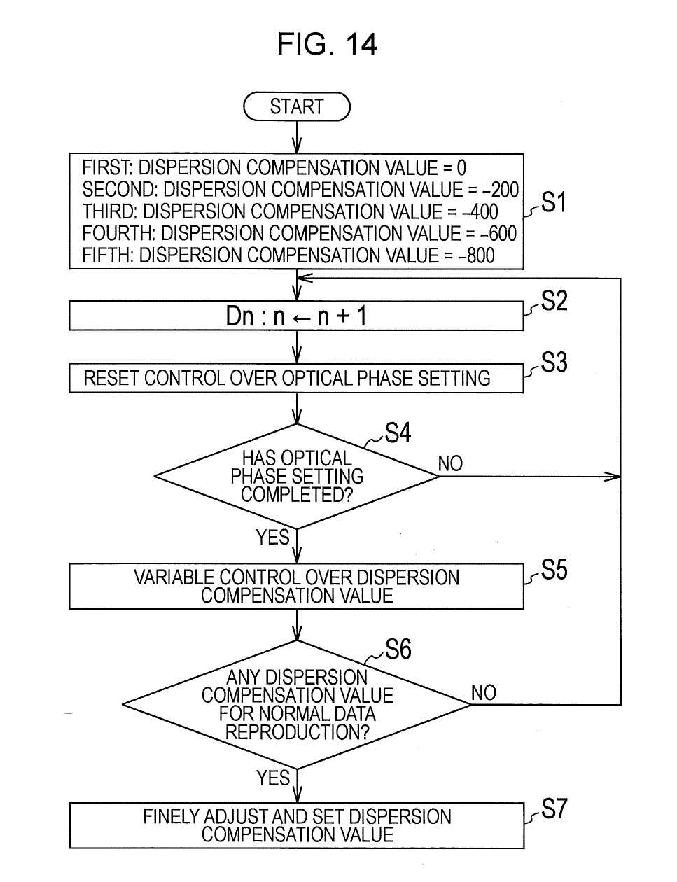

Next, the sequence control over the dispersion compensation will be described. FIG. 14 is a flowchart illustrating the dispersion compensation sequence control.

[S1] In order to compensate the wavelength dispersion caused by optical fiber transmission, the control section 30 holds in advance different plural dispersion compensation values in a memory. For example, it is assumed that dispersion compensation values D1=0, D2=−200, D3=−400, D4=−600 and D5=−800 (the unit of which will be omitted herein) are registered.

[S2] The control section 30 increments n by +1 (where n=0 upon start of the apparatus such as upon powered on) and sets a dispersion compensation value Dn to the VDC 1a. For example, the first dispersion compensation value upon start of the apparatus may be set as dispersion compensation value D1=0. When the optical phase setting has not completed with the dispersion compensation value D1=0 or when the optical phase setting has completed with the dispersion compensation value D1=0 but the data reproducing section 20 has not normally operated, the dispersion compensation value D2=−200 is set as the second dispersion compensation value.

[S3] The control section 30 transmits a reset signal to the A arm temperature control section 32a and B arm temperature control section 32b to rest the optical phase setting control.

[S4] The control section 30 determines whether the optical phase setting has completed on the delay interferometers 11-1 and 11-2 within a predetermined period of time or not. In other words, the control section 30 has a timer and determines whether the monitor values m1 and m2 are both equal to 0 within a predetermined period of time or not. If the optical phase setting has completed within a predetermined period of time (or the monitor values m1 and m2 are both equal to 0), the processing moves to step S5 (meaning the shift to variable control for sweeping the dispersion compensation value). If the optical phase setting has not completed within the predetermined period of time (or even one of the monitor values m1 and m2 is not equal to 0), the processing returns to step S2.

[S5] The control section 30 performs variable control that sweeps the dispersion compensation value in the plus direction and minus direction about the dispersion compensation value set in step S2.

[S6] Whether any dispersion compensation value that allows the data reproducing section 20 to normally operate exists within the sweep range or not (or whether the clocks ck1 and ck2 can be received from the data reproducing section 20 or not) is determined.

For example, when the completion of the optical phase setting is recognized with the dispersion compensation value D2=−200, the dispersion compensation value is swept in the plus direction and minus direction about −200. Then, within the sweep range, the range of the dispersion compensation values with which both of the clocks ck1 and ck2 can be normally received is detected.

If the dispersion compensation value range with which the normal operation by the data reproducing section 20 can be recognized is detected within the predetermined period of time (or both of the clocks ck1 and ck2 are received normally), the processing moves to step S7. If the dispersion compensation value range with which the normal operation by the data reproducing section 20 can be recognized is not detected within the predetermined period of time (or both of the clocks ck1 and ck2 are not normally received), the processing returns to step S2.

[S7] The control section 30 in step S6 finely adjusts the dispersion compensation value within the detected range (that is, the dispersion compensation value range), detects the point where the error value e is at a minimum (which is called optimum dispersion compensation value) and finally sets the acquired optimum dispersion compensation value to the VDC 1a.

Next, with reference to the flowchart in FIG. 14, dispersion compensation sequence control by using a concrete numerical value will be described. It is assumed that the delay interferometers 11-1 and 11-2 and CDR have the characteristics illustrated in FIG. 12 (where the wavelength dispersion range with which the CDR sections 21a and 21b lock is −100 ps/nm to +100 ps/nm). It is further assumed that the dispersion value for the optical fiber transmission line is +650 ps/nm, the dispersion value guarantee range for the optical receiver 1 is 0 to +800 ps/nm, the initial dispersion compensation set value for the VDC is 0 ps/nm.

The dispersion compensation set value for the VDC is set to 0 (first flow) (step S2), and the optical phase setting control is reset (step S3).

In step S4, the delay interferometers 11-1 and 11-2 await the lock. Here, because the transmission path dispersion value is +650 ps/nm and the set value for the VDC is 0, the residual dispersion value to be input to the delay interferometers 11-1 and 11-2 is +650 ps/nm.

Under this condition, if the optical phase is away from the convergence point by nearly 40°, there is a possibility of occurrence of the improper lock of the delay interferometers 11-1 and 11-2. In this case, the delay interferometers 11-1 and 11-2 are locked (which is the improper lock) in step S4, and the dispersion compensation value is automatically varied (in step S5). Then, the extraction of the clock indicating that the CDRs 21a and 21b have been locked is checked. However, because the delay interferometers 11-1 and 11-2 are improper locked, the CDRs 21a and 21b are not locked, and normal clocks ck1 and ck2 are not output.

If the CDRs 21a and 21b are not locked within a predetermined period of time, the processing returns to step S2 (step S6), the second dispersion compensation value (−200 ps/nm) is set to the VDC 1a (step S2), and the optical phase setting control is reset (step S3).

In this case, the set value for the VDC 1a is −200 ps/nm against the transmission path dispersion value +650 ps/nm. Therefore, the residual dispersion value to be input to the delay interferometers 11-1 and 11-2 is +450 ps/nm.

In FIG. 12, the dispersion value +450 ps/nm is still out of the operation range of the delay interferometers 11-1 and 11-2. Therefore, there is still a possibility of occurrence of the improper lock, and it is assumed here that they are improper locked. In the same manner, the third value −400 ps/nm is set to the VDC (step S2), and the optical phase setting control is reset (step S3).

In this case, the residual dispersion value is +250 ps/nm, and there still is a possibility of occurrence of the improper lock with reference to FIG. 12. Next, Fourth, −600 ps/nm is set to the VDC (step S2), and the optical phase setting control is reset (step S3).

In this case, the residual dispersion value to be input to the delay interferometers 11-1 and 11-2 is +50 ps/nm, which is within the operable range of the delay interferometers 11-1 and 11-2 with reference to FIG. 12. The optical phase setting control is performed on the delay interferometers 11-1 and 11-2 (step S4), and if the delay interferometers 11-1 and 11-2 are locked (which is the normal lock), the dispersion compensation value is varied about −600 ps/nm (step S5). Then, the dispersion compensation value range with which the CDRs 21a and 21b are locked is extracted (step S6). If the CDRs 21a and 21b are locked, the dispersion compensation value set in the VDC 1a is automatically finely adjusted to find the optimum point such that the error value e can be minimized, (step S7). Then, the dispersion compensation control sequence is completed.

Here, the delay interferometers 11-1 and 11-2 have a dispersion range with which they can operate normally (or the optical phases can be adjusted). Within the dispersion range, the optical phase setting control is possible, and a DQPSK signal can be demodulated. On the other hand, out of the dispersion range, as described above, there is a possibility that the delay interferometers 11-1 and 11-2 may be improperly locked.

On the other hand, the dispersion value of the optical fiber transmission line on which the transponder (which is the optical receiver 1) is actually placed may be higher than the operation compensation range of the delay interferometers 11-1 and 11-2. Therefore, it is important to lower the residual dispersion value through the VDC 1a.

When the dispersion value of the optical fiber transmission line is known in advance, the VDC is upon initial start may be adjusted to have the value for correcting the dispersion value of the optical fiber transmission line. Thus, the residual dispersion value to be input to the delay interferometers 11-1 and 11-2 can be lowered. When the dispersion value of the optical fiber transmission line on which the transponder is to be placed is not known, it is important to perform the dispersion compensation sequence control based on the flow illustrated in FIG. 14.

By performing the dispersion compensation sequence control as described above, an optimum dispersion compensation value can be efficiently set to the VDC is against any wavelength dispersion of the optical fiber transmission line. Therefore, the signals can be demodulated.

Next, variation examples of the dispersion compensation sequence control will be described. In the sequence illustrated in FIG. 14, the initial dispersion value is set to the VDC 1a, and, after the delay interferometers 11-1 and 11-2 are locked, variable control is performed on the set dispersion compensation value. Because the control is performed for detecting a proper dispersion compensation value every time upon start of the receiver, time is consumed until the signal communication is enabled.

Therefore, in sequence control of a variation example, the dispersion compensation value set to the VDC is during the operation of the apparatus is held in a memory as a backup value. Then, upon restart after the power shuts down, the held dispersion compensation value is set to the VDC is to start the dispersion compensation sequence control.

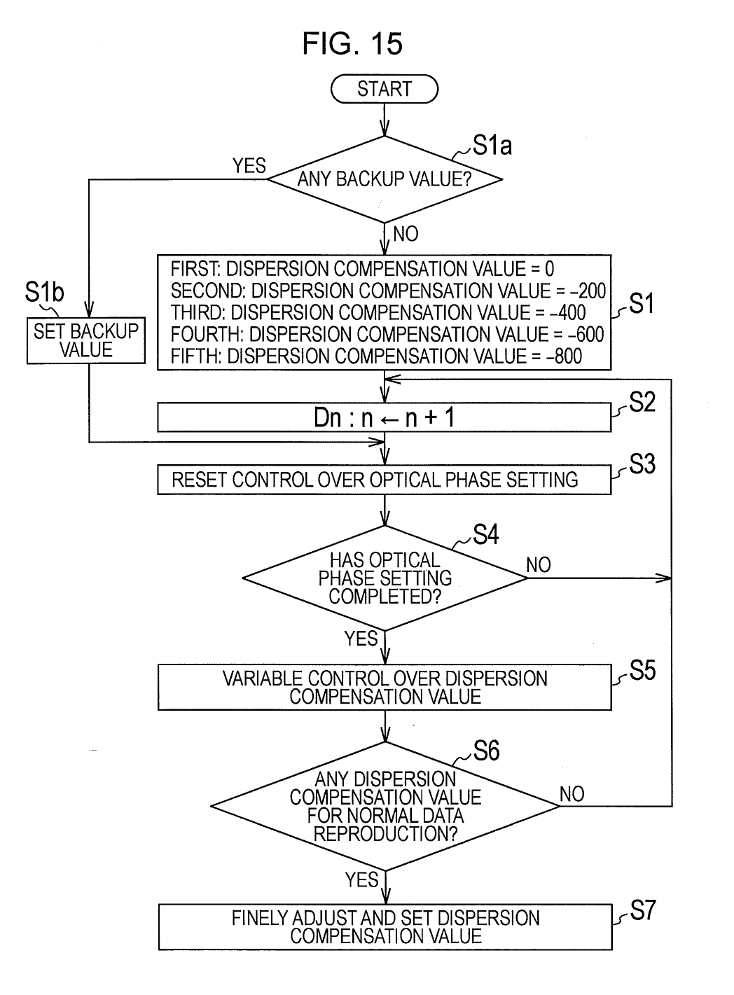

FIG. 15 illustrates a flowchart for the dispersion compensation sequence control.

[S1a] The control section 30 determines whether any backup value is available or not upon start of the apparatus. If not, the processing moves to step S1. If so, the processing moves to step S1b. Notably, if no backup values are available, the same processing as that in the flow in FIG. 14 is performed, except for the case that the determination in steps S4 and S5 results in No and the processing returns to step S1a. The description will be omitted herein.

[S1b] The control section 30 sets the backed up dispersion compensation value to the VDC 1a, and the processing moves to step S3. The subsequent operations are basically the same as those in the flow in FIG. 14.

In this way, a dispersion compensation value during the operation of the apparatus is held, and, upon restart, the held dispersion compensation value is used to start the sequence control. Thus, upon restart after power discontinuity, for example, a proper dispersion compensation value can immediately be set to the VDC 1a, which can reduce the time required for signal communication.

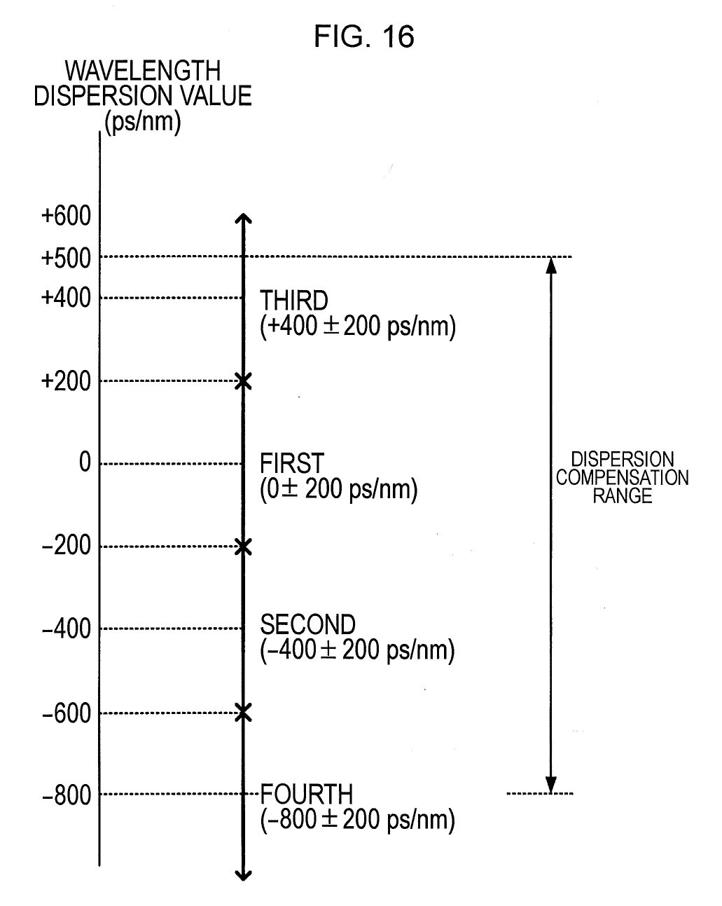

Next, the sweep ranges will be described regarding the registration of a dispersion compensation value with the control section 30 (step S1 in FIG. 14) and a case where the dispersion compensation value is variably controlled (step S5 in FIG. 14). FIG. 16 is a diagram illustrating a dispersion compensation range. FIG. 16 illustrates a dispersion tolerance characteristic allowing dispersion compensation by the optical receiver 1. In this example, wavelength dispersions of −800 ps/nm to +500 ps/nm are the range allowing the dispersion compensation.

The first dispersion compensation value=0 ps/nm, the second dispersion compensation value=−400 ps/nm, the third dispersion compensation value=+400 ps/nm and the fourth dispersion compensation value=−800 ps/nm are registered in advance in a memory within the control section 30.

It is further assumed that, for each of the registered values, −200 ps/nm (which is equal to 400 ps/nm in width) is the sweep range of the dispersion compensation value. For example, in order to variably control the dispersion compensation value from the first dispersion compensation value=0 ps/nm, the dispersion compensation value range with which the CDRs 21a and 21b are locked (that is, the data reproducing section 20 normally operates) is detected in the sweep range −200 ps/nm to +200 ps/nm.

For example, in order to variably control the dispersion compensation value from the second dispersion compensation value=−400 ps/nm, the dispersion compensation value range with which the CDRs 21a and 21b are locked is detected in the sweep range −600 ps/nm to +600 ps/nm. By further finely adjusting the dispersion compensation value within the detected dispersion compensation value range, the point (optimum dispersion compensation value) which minimizes the error value e can be detected.

Here, the plural dispersion compensation value to be registered in advance and the sweep range are determined on the basis of the dispersion tolerance characteristic of the optical receiver 1 and a tolerable error value e.

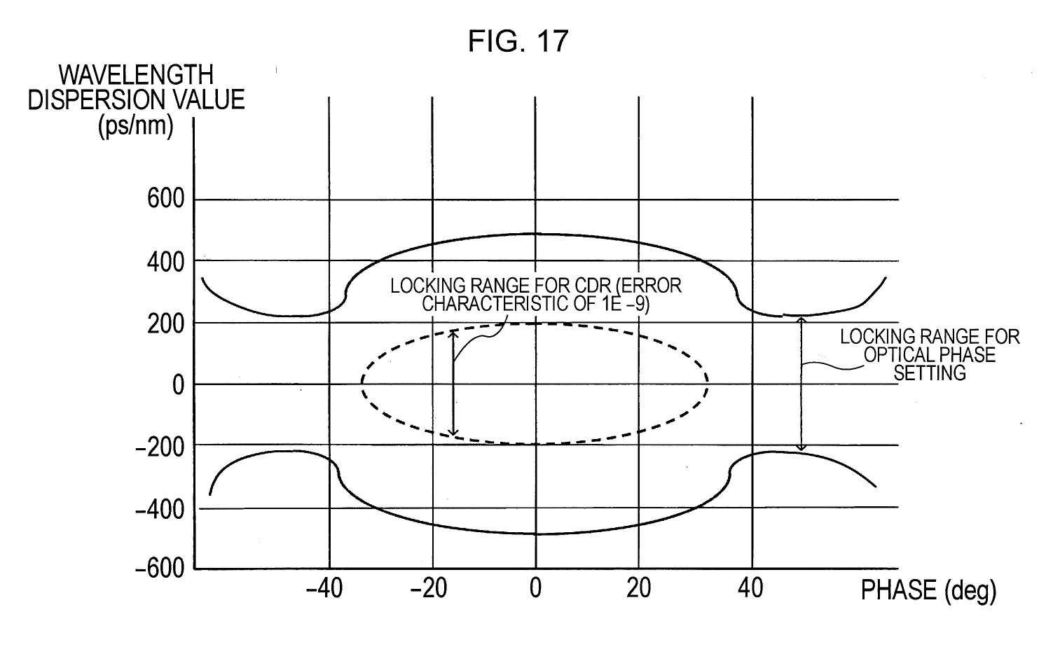

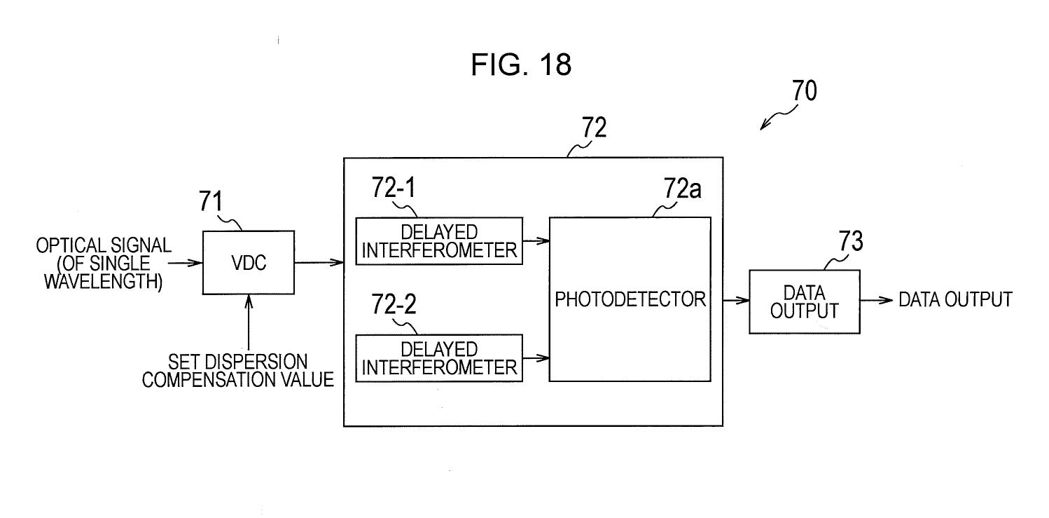

In the example above, if the dispersion tolerance characteristic is −800 ps/nm to +500 ps/nm and the range 400 ps/nm wide provides an error characteristic equal to or lower than 1E−9, the dispersion compensation values to be registered are values 0, −400, +400 and −800, and the sweep range of them is −200 ps/nm to +200 ps/nm. This can cover all dispersion values within the range of the dispersion tolerance characteristic. Notably, the locking range for the optical phase setting and the locking range for clock extraction control corresponding to FIG. 16 are illustrated in FIG. 17.

As described above, according to the embodiments, an optimum dispersion compensation value can be efficiency set without deadlock even when a delay interferometer is improperly locked. Even when the apparatus having it is shut down due to instantaneous power discontinuity, for example, and is restarted, the time required for the dispersion compensation sequence control can be reduced, and the signal recovery time can be greatly reduced. Therefore, the reliability can be improved.

In order to prevent the phenomenon that signal communication is disabled by improper setting of an optical phase, dispersion compensation sequence control variably sets the dispersion compensation value for improvement in transmission quality and reliability.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An optical receiver for receiving a processing modulated optical signal, the optical receiver comprising:
a variable dispersion compensator for receiving the optical signal and for compensating chromatic dispersion of the optical signal in accordance with a predetermined chromatic dispersion value;
a demodulator including a delay interferometer for receiving the compensated optical signal and for changing a phase moderation information of the compensated optical signal into an amplitude moderation information, and an optical demodulator for changing the amplitude moderation information of the optical signal into an electrical signal;
a data regenerator for extracting a clock from the electric signal and for regenerating data from the electric signal by the use of the clock; and
a controller for setting an optical phase to the delay interferometer and for setting the dispersion compensation value to the variable dispersion compensator,
wherein the controller resets the optical phase to the delay interferometer when the controller recognizes that the optical phase has been set in the delay interferometer upon start of the optical receiver but a normal operation of the data regenerator is unperformed within a predetermined period of time, and performs dispersion compensation sequence control that sequentially sets different chromatic dispersion compensation value until an optical phase is set to the delay interferometer and the normal operation by the data regenerator is recognized.

2. The optical receiver of claim 1, further comprising an error detector for detecting an error and for correcting the error from the data outputting from the data regenerator;
wherein the controller performs to set the chromatic dispersion value so as to decrease the error in the error detector.

3. The optical receiver of claim 1, wherein the controller stores the chromatic dispersion value in service status, and wherein the controller sets the stored chromatic dispersion value in service status when the optical receiver restarts.

4. The optical receiver of claim 1, wherein the controller stores a plurality of predetermined chromatic dispersion compensation values and resets a chromatic dispersion compensation value in the predetermined chromatic dispersion compensation values when the controller recognizes that absence of the optical phase has been set in the delay interferometer upon start of the optical receiver.

5. The optical receiver of claim 4, further comprising an error detector for detecting an error and for correcting the error from the data outputting from the data regenerator;
wherein the controller performs to set the chromatic dispersion value so as to decrease the error in the error detector.

6. A method for compensating chromatic dispersion of a modulated optical signal in an optical receiver, the method comprising:
preparing a variable dispersion compensator for receiving the optical signal and for compensating chromatic dispersion of the optical signal in accordance with a predetermined chromatic dispersion value, a demodulator including a delay interferometer for receiving the compensated optical signal and for changing a phase moderation information of the compensated optical signal into an amplitude moderation information, and an optical demodulator for changing the amplitude moderation information of the optical signal into an electrical signal, and a data regenerator for extracting a clock from the electric signal and for regenerating data from the electric signal by the use of the clock;
resetting the optical phase to the delay interferometer when an optical phase has been set in the delay interferometer upon start of the optical receiver but a normal operation of the data regenerator is unperformed within a predetermined period of time; and
performing dispersion compensation sequence control that sequentially sets different dispersion compensation values until an optical phase is set to the delay interferometer and the normal operation by the data regenerator is recognized.

7. The method of claim 6, further comprising detecting an error; correcting the error from the data outputting from the data regenerator; and setting the chromatic dispersion value so as to decrease the error in the error detector.

8. The method of claim 6, further comprising storing the chromatic dispersion value in service status; and setting the stored chromatic dispersion value in service status when the optical receiver restarts.

9. The method of claim 6, further comprising storing a plurality of predetermined chromatic dispersion compensation values; and resetting a chromatic dispersion compensation value in the predetermined chromatic dispersion compensation values when the controller recognizes that absence of the optical phase has been set in the delay interferometer upon start of the optical receiver.

10. The method of claim 9, further comprising detecting an error; correcting the error from the data outputting from the data regenerator; and performing to set the chromatic dispersion value so as to decrease the error in the error detector.
